(19) United States
(12) Patent Application Publication
(10) Pub. No.: US 2025/0300390 A1
(43) Pub. Date: Sep. 25, 2025

(54) Conversion Socket

(71) Applicant: Anker Innovations Technology Co., Ltd., Changsha (CN)

(72) Inventor: Xianjie Tang, Changsha (CN)

(21) Appl. No.: 19/086,872

(22) Filed: Mar. 21, 2025

(30) Foreign Application Priority Data
Mar. 22, 2024 (CN) 202420580053.4

(51) Int. Cl. H01R 13/426; H01R 13/04; H01R 31/06

(52) U.S. Cl. CPC H01R 13/426; H01R 13/04; H01R 31/065

(57) ABSTRACT

A conversion socket includes: a first and second sliders and a first, second, and third plug assemblies. The first slider slides along a first direction, and includes a first end and a second end. A portion of the first plug assembly extends or retracts along a second direction in a first insertion hole, to abut against or separate from the first end. A portion of the second plug assembly extends or retracts along the second direction in a second insertion hole, to abut against or separate from the second end. The second direction is perpendicular to the first direction. The second slider slides along a third direction. The third direction is perpendicular to the first direction and the second direction. A portion of the third plug assembly extends or retracts along the second direction in a third insertion hole, to abut against or separate from the second slider.

### CROSS-REFERENCE TO RELATED APPLICATION

The present application claims priority to CN 202420580053.4, filed on Mar. 22, 2024, which is incorporated by reference in its entirety.

### FIELD

The present application relates to the field of electronics, in particular, to a conversion socket.

### BACKGROUND

In today's society, global travel is becoming increasingly common. In different countries or regions, due to different socket specifications, users usually carry multi-country conversion sockets for plugs of their electrical or electronic products.

Common conversion sockets currently in the market are mostly heavy and inconvenient to carry. Because a plurality of plug assemblies that can be used for different socket specifications are provided inside a conversion socket, when one of the plug assemblies is pulled out of the conversion socket for use, the other plug assemblies are easily interfered or stuck together. As a result, two or more plug assemblies extend out of the conversion socket at the same time, which not only affects normal use, but also may incur safety hazards, such as an electric shock to a user, spark breakdown occurring in the socket, or a fire caused by socket overheating.

### SUMMARY

The present application provides a conversion socket, which can better reduce the risk of simultaneous ejection of a plurality of plug assemblies therein, is convenient and safe in use, has a small size to improve portability, causes few safety hazards, and provides high reliability and user experience.

To solve the above problems, the present application provides a conversion socket, including a support layer, a first slider, a second slider, a first plug assembly, a second plug assembly, and a third plug assembly. The first slider is connected to the support layer in a sliding manner along a first direction. The first slider is provided with a first end and a second end, and the first end and the second end are arranged along the first direction. The first plug assembly is arranged on the support layer, and at least a portion of the first plug assembly extends or retracts along a second direction in the first insertion hole, so as to abut against or separate from the first end of the first slider. The second plug assembly is arranged on the support layer, and at least a portion of the second plug assembly extends or retracts along the second direction in the second insertion hole, so as to abut against or separate from the second end of the first slider. The second direction is perpendicular to the first direction. The second slider is connected to the support layer in a sliding manner along a third direction, where the third direction is perpendicular to the first direction and the second direction. The third plug assembly is arranged on the support layer, and at least a portion of the third plug assembly extends or retracts along the second direction in the third insertion hole, so as to abut against or separate from the second slider. The first slider is provided with a first clamp, the second slider includes a second clamp, and the first clamp and the second clamp are clamped or separated along the first direction or the third direction.

The first clamp includes a first clamping groove, a second clamping groove and a third clamping groove. The first clamping groove is arranged in the middle of the side of the first slider near the second slider, and the second clamping groove and the third clamping groove are arranged on two sides, opposite along the third direction, of a bottom wall of the first clamping groove. The first clamping groove penetrates through the first slider along the third direction. The second clamp includes a fourth clamping groove, a fifth clamping groove and a sixth clamping groove. The fourth clamping groove is arranged in the middle of the side of the second slider near the first slider, and the fifth clamping groove and the sixth clamping groove are arranged on two sides, opposite along the first direction, of a bottom wall of the fourth clamping groove. The fourth clamping groove penetrates through the second slider along the first direction. An inner wall of the first clamping groove is spaced apart or clamped with an inner wall of the fifth clamping groove and/or an inner wall of the sixth clamping groove along the first direction. An inner wall of the fourth clamping groove is spaced apart or clamped with an inner wall of the second clamping groove and/or an inner wall of the third clamping groove along the third direction.

Two opposite inner walls of the first clamping groove along the first direction are arranged in a V-shaped structure. The inner wall of the fifth clamping groove and the inner walls of the sixth clamping groove are each arranged in a V-shaped structure that matches the two opposite inner walls of the first clamping groove. Two opposite inner walls of the fourth clamping groove along the third direction are arranged in a V-shaped structure. The inner wall of the second clamping groove and the inner wall of the third clamping groove are each arranged in a V-shaped structure that matches the two opposite inner walls of the fourth clamping groove.

The V-shaped structure of the first clamping groove protrudes into the first clamping groove. The V-shaped structure of the fourth clamping groove protrudes into the fourth clamping groove.

The support layer is further provided with a fourth insertion hole. The second slider is provided with a third end and a fourth end. The third end and the fourth end are arranged along the third direction. The conversion socket further includes: a fourth plug assembly arranged on the support layer. At least a portion of the fourth plug assembly extends or retracts along the second direction in the fourth insertion hole, so as to abut against or separate from the fourth end. At least a portion of the third plug assembly extends or retracts along the second direction in the third insertion hole, so as to abut against or separate from the third end.

The second plug assembly is provided with a first groove on one side near the first slider. The first slider is in clamping fit with the first groove to achieve the abutment between the second plug assembly and the first slider.

The end surface of the first end is provided with a first inclined surface, and the angle between the first inclined surface and the side of the first end away from the support layer is an acute angle The end surface of the second end is provided with a second inclined surface, and the angle between the second inclined surface and the side of the second end away from the support layer is an acute angle.

The conversion socket further includes: three controllers, which are connected to the first plug assembly, the second plug assembly, and the third plug assembly, to control the extension and retraction of the first plug assembly in the first insertion hole, the extension and retraction of the second plug assembly in the second insertion hole, and the extension and retraction of the third plug assembly in the third insertion hole, respectively.

A limit column extends from the side of the support layer away from the first slider along the second direction. At least one of the three controllers is provided with a limit hole, and the limit column is at least partially arranged in the limit hole.

The conversion socket further includes an upper shell and a lower shell. The upper shell is formed with a first through hole and a second through hole, the first through hole is in communication with the first insertion hole, and the second through hole is in communication with the second insertion hole. The lower shell forms an accommodating chamber with the upper shell. The support layer, the first slider, the first plug assembly, and the second plug assembly are arranged in the accommodating chamber.

A conversion socket includes a first slider configured to slide along a first direction. The first slider includes a first end and a second end, and the first end and the second end are arranged along the first direction. The conversion socket further includes a first plug assembly. At least a portion of the first plug assembly is configured to extend or retract along a second direction in a first insertion hole, to abut against or separate from the first end of the first slider. The conversion socket further includes a second plug assembly. At least a portion of the second plug assembly is configured to extend or retract along a second direction in a second insertion hole, to abut against or separate from the second end of the first slider. The second direction is perpendicular to the first direction. The conversion socket further includes a second slider configured to slide along a third direction. The third direction is perpendicular to the first direction and the second direction. The conversion socket includes a third plug assembly. At least a portion of the third plug assembly is configured to extend or retract along the second direction in a third insertion hole, to abut against or separate from the second slider.

The conversion socket further includes a support layer. The first and second sliders are connected to the support layer, the first, second and third plug assemblies are arranged on the support layer, and the first, second, and third insertion holes are mounted through the support layer.

The second slider includes a third end and a fourth end, the third end and the fourth end are arranged along the third direction. The conversion socket further includes a fourth plug assembly. At least a portion of the fourth plug assembly is configured to extend or retract along the second direction in a fourth insertion hole, to abut against or separate from the fourth end. The fourth plug assembly is arranged on the support layer and the fourth insertion hole is mounted through the support layer. At least a portion of the third plug assembly is configured to extend or retract along the second direction in the third insertion hole, to abut against or separate from the third end.

The conversion socket further includes an upper shell formed with a first through hole and a second through hole. The first through hole is in communication with the first insertion hole, and the second through hole is in communication with the second insertion hole. The conversion socket further includes a lower shell forming an accommodating chamber with the upper shell. The support layer, the first slider, the first plug assembly, and the second plug assembly are arranged in the accommodating chamber.

The first slider includes a first clamp, the second slider includes a second clamp. The first clamp and the second clamp are clamped or separated along the first direction or the third direction.

The first clamp includes a first clamping groove, a second clamping groove and a third clamping groove. The first clamping groove is arranged in a middle of a side of the first slider near the second slider, and the second clamping groove and the third clamping groove are arranged on two sides, opposite along the third direction, of a bottom wall of the first clamping groove. The first clamping groove penetrates through the first slider along the third direction. The second clamp includes a fourth clamping groove, a fifth clamping groove and a sixth clamping groove. The fourth clamping groove is arranged in a middle of a side of the second slider near the first slider, and the fifth clamping groove and the sixth clamping groove are arranged on two sides, opposite along the first direction, of a bottom wall of the fourth clamping groove. The fourth clamping groove penetrates through the second slider along the first direction. An inner wall of the first clamping groove is spaced apart or clamped with an inner wall of the fifth clamping groove and/or an inner wall of the sixth clamping groove along the first direction. An inner wall of the fourth clamping groove is spaced apart or clamped with an inner wall of the second clamping groove and/or an inner wall of the third clamping groove along the third direction.

Two opposite inner walls of the first clamping groove along the first direction are arranged in a V-shaped structure. The inner wall of the fifth clamping groove and the inner wall of the sixth clamping groove are each arranged in a V-shaped structure that matches the two opposite inner walls of the first clamping groove. Two opposite inner walls of the fourth clamping groove along the third direction are arranged in a V-shaped structure. The inner wall of the second clamping groove and the inner wall of the third clamping groove are each arranged in a V-shaped structure that matches the two opposite inner walls of the fourth clamping groove.

The V-shaped structure of the first clamping groove protrudes into the first clamping groove. The V-shaped structure of the fourth clamping groove protrudes into the fourth clamping groove.

The conversion socket further includes three controllers, which are connected to the first plug assembly, the second plug assembly, and the third plug assembly, to control the extension and retraction of the first plug assembly in the first insertion hole, the extension and retraction of the second plug assembly in the second insertion hole, and the extension and retraction of the third plug assembly in the third insertion hole, respectively.

A limit column extends from a side of the support layer away from the first slider along the second direction. At least one of the three controllers includes a limit hole, and the limit column is at least partially arranged in the limit hole.

Beneficial effects of the present application are as follows: the first slider is arranged on the support member, the first slider slides along the first direction, and the support member limits the first slider, such that the first slider can only slide left and right along the first direction; when the first plug assembly extends out of the first insertion hole, the first slider can cover at least a portion of the second insertion hole, which can reduce the risk that the second plug assembly is interfered or carried out of the second insertion hole; similarly, when the second plug assembly extends out of the second insertion hole, the first slider can cover at least a portion of the first insertion hole, to reduce the risk that the first plug assembly is interfered or carried out of the first insertion hole; further, the second slider and the first slider are clamped or separated through the first clamping portion and the second clamping portion, and the second slider can abut against or separate from the third plug assembly, such that the first plug assembly, the second plug assembly, and the third plug assembly limit each other, thereby further reducing the risk of simultaneous ejection of a plurality of plug assemblies in the conversion socket; further, this example has a simple structure, can prevent interference between the plug assemblies without adding other limit mechanisms, and can reduce the overall size of the conversion socket and improve product portability; further, this example has a simple structure, and facilitates multiplexing or further extension of functional modules of other specifications in the conversion socket. Therefore, the present application can better reduce the risk of simultaneous ejection of the plug assemblies in the conversion socket, improve the use convenience and safety of the conversion socket, reduce product size to improve portability, reduce safety hazards, and improve product reliability and user experience.

### BRIEF DESCRIPTION OF THE DRAWINGS

To describe examples of the present application, the following introduces the accompanying drawings used for the description of the examples. The accompanying drawings in the following description show only some examples of the present application, and those of ordinary skill in the art can further derive other drawings from the accompanying drawings without any creative effort. In the figures:

FIG. 1 is a schematic structural diagram of an example of a conversion socket in the present application;

FIG. 2 is an exploded structural diagram of the example in FIG. 1;

FIG. 3 is a schematic top view of the example in FIG. 1;

FIG. 4 is a schematic top view of some structures of the example in FIG. 1;

FIG. 5 is a schematic structural diagram of an example of a first slider and a second slider in the present application;

FIG. 6 is a schematic structural diagram of an example of the first slider in the present application;

FIG. 7 is a schematic structural diagram of an example of the second slider in the present application;

FIG. 8 is a schematic cross-sectional view of the conversion socket in the present application taken along a direction A in the example of FIG. 4;

FIG. 9 is a schematic structural diagram of an example of an operation member in the present application;

FIG. 10 is a partial structural diagram of an example of the conversion socket in the present application;

FIG. 11 is a partial structural diagram of an example of the conversion socket in the present application; and

FIG. 12 is a schematic cross-sectional view of the conversion socket in the present application taken along a direction B in the example of FIG. 4.

### DETAILED DESCRIPTION

The following examples of the present application in conjunction with the accompanying drawings therein. The described examples are only some of the examples of the present application, not all of them. According to the examples in the present application, all other examples obtained by those of ordinary skill in the art without any creative efforts fall within the scope of protection of the present application.

The terms “first”, “second”, etc. in the present application are used for distinguishing different objects, not for describing a specific order. In addition, the term “include” and “have” and any variant thereof are intended to cover a non-exclusive inclusion.

It should be noted that, when one element is fixed to other element, the element is directly fixed to the other element, or the element is fixed to the other element by at least one other medium element. When one element is connected to other element, the element is directly connected to the other element, or the element is connected to the other element by at least one other medium element.

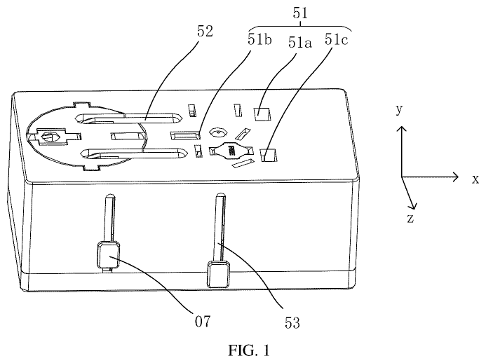

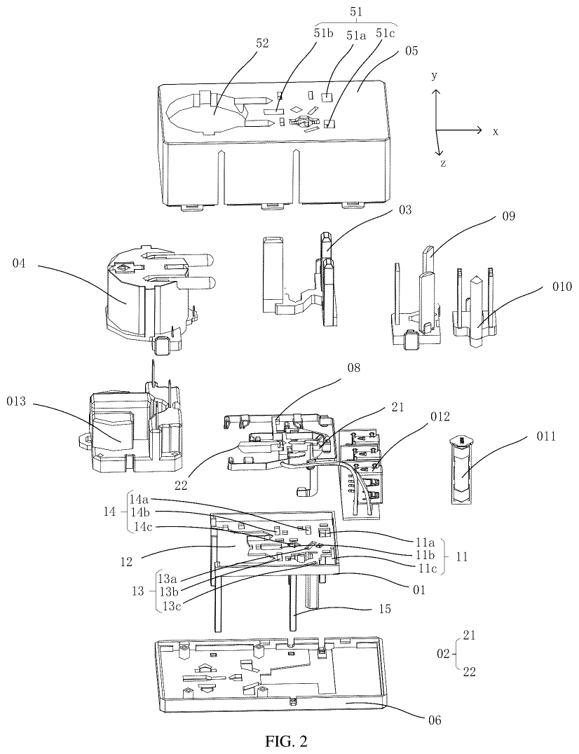

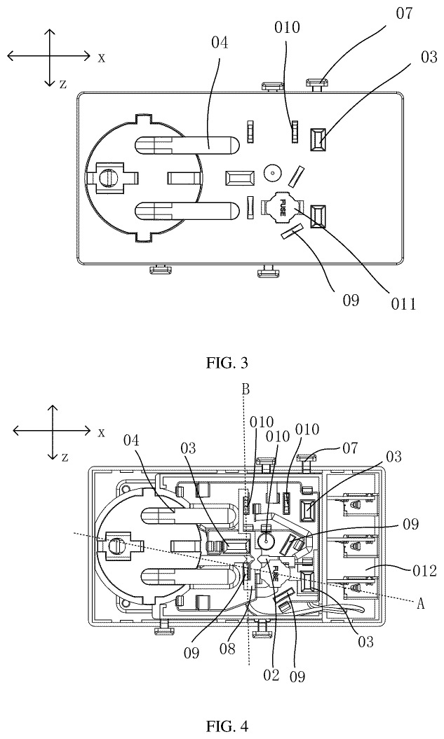

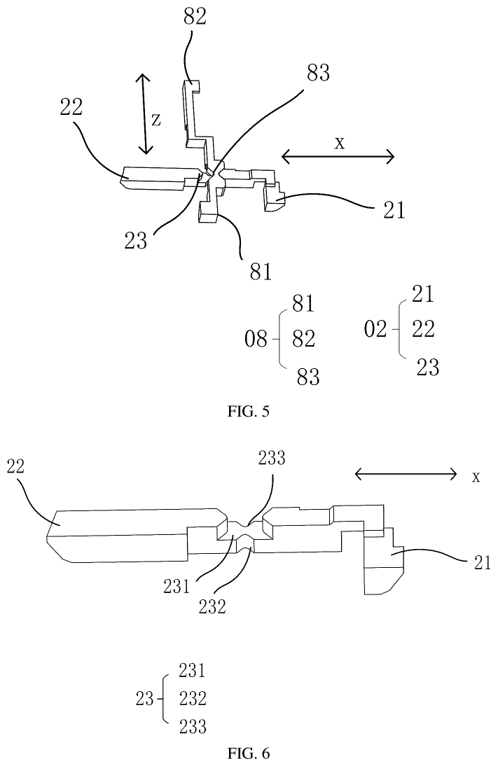

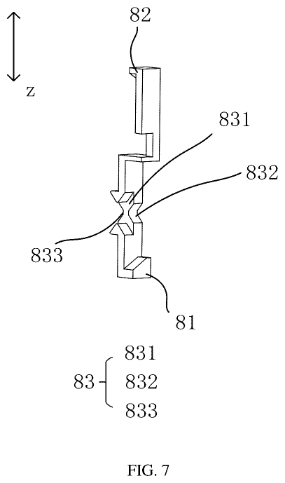

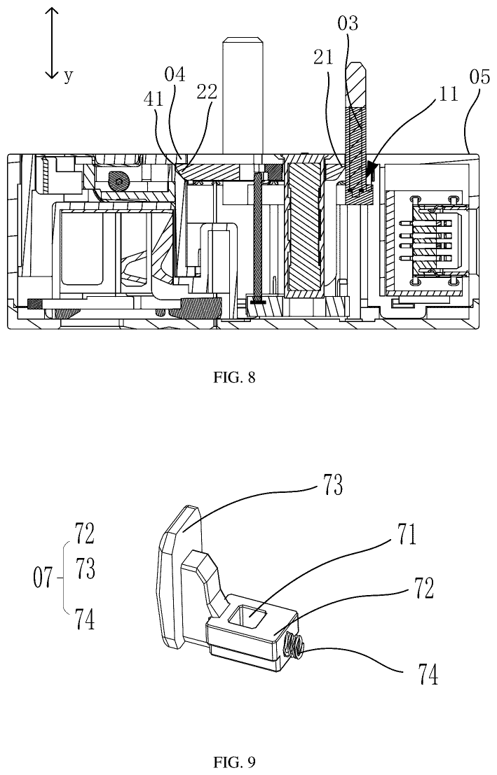

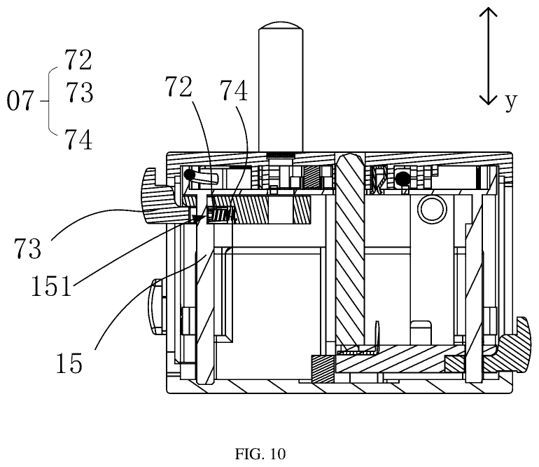

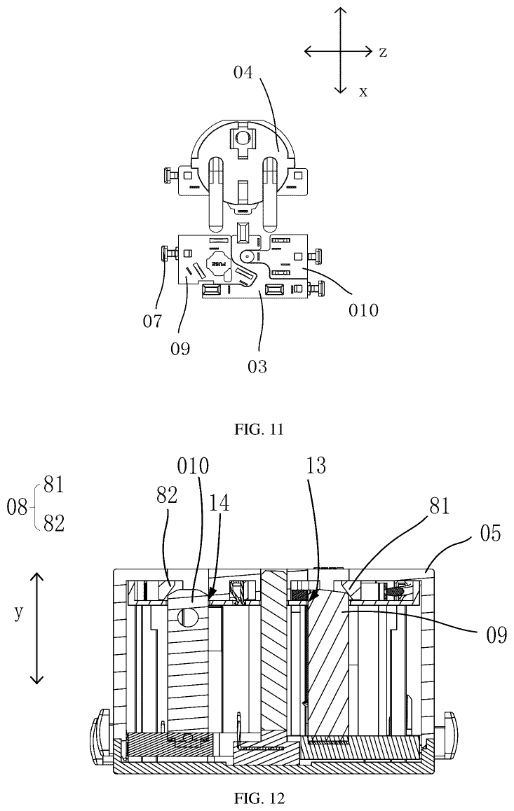

The present application first provides a conversion socket, as shown in FIG. 1 to FIG. 12. FIG. 1 is a schematic structural diagram of an example of a conversion socket in the present application; FIG. 2 is an exploded structural diagram of the example in FIG. 1; FIG. 3 is a schematic top view of the example in FIG. 1; FIG. 4 is a schematic top view of some structures of the example in FIG. 1; FIG. 5 is a schematic structural diagram of an example of a first slider and a second slider in the present application; FIG. 6 is a schematic structural diagram of an example of the first slider in the present application; FIG. 7 is a schematic structural diagram of an example of the second slider in the present application; FIG. 8 is a schematic cross-sectional view of the example of FIG. 4 at section A; FIG. 9 is a schematic structural diagram of an example of an operation member in the present application; FIG. 10 is a partial structural diagram of an example of the conversion socket in the present application; FIG. 11 is a partial structural diagram of an example of the conversion socket in the present application; FIG. 12 is a schematic cross-sectional view of the example of FIG. 4 at section B. The conversion socket includes a support member 01 (e.g., a support layer, a base, a housing), a first slider 02, a first plug assembly 03 (e.g., a first plug assembly 03 may at least include one or more pins or one or more prongs), and a second plug assembly 04 (e.g., a second plug assembly 04 may at least include one or more grooves), where the support member 01 is provided with a first insertion hole 11 (including 11a, 11b, and 11c) and a second insertion hole 12; the first slider 02 is connected to the support member 01 in a sliding manner along a first direction x, the first slider 02 is provided with a first end 21 and a second end 22, and the first end 21 and the second end 22 are arranged along the first direction x; the first plug assembly 03 is arranged on the support member 01, and at least a portion of the first plug assembly 03 can extend and retract along a second direction y in the first insertion hole 11, so as to abut against or separate from the first end 21; the second plug assembly 04 is arranged on the support member 01, and at least a portion of the second plug assembly 04 can extend and retract along the second direction y in the second insertion hole 12, so as to abut against or separate from the second end 22; the second direction y is perpendicular to the first direction x.

The first slider 02 is connected to the support member 01 in the sliding manner along the first direction x, and the support member 01 limits the first slider 02, such that the first slider 02 can only slide left and right along the first direction x.

As shown in FIG. 4 and FIG. 8, the movement of the first plug assembly 03 or the second plug assembly 04 in the second direction y pushes the first slider 02 to slide left and right in the first direction x, so the three can limit each other. Specifically, when at least a portion of the first plug assembly 03 extends out of the first insertion hole 11 along the second direction y, the first plug assembly 03 at least partially abuts against the first end 21 of the first slider 02 and pushes the first slider 02 to move along the first direction x, such that the second end 22 covers at least a portion of the second insertion hole 12 to prevent the second plug assembly 04 from extending out of the second insertion hole 12. When at least a portion of the second plug assembly 04 extends out of the second insertion hole 12 along the second direction y, the second plug assembly 04 abuts against the second end 22 of the first slider 02 and pushes the first slider 02 to move along the first direction x, such that the first end 21 covers at least a portion of the first insertion hole 11 to prevent the first plug assembly 03 from extending out of the first insertion hole 11.

Additionally and/or alternatively, the second plug assembly 04 is provided with a first groove 41 on one side near the first slider 02, and the first slider 02 is in clamping fit with the first groove 41 to achieve the abutment between the second plug assembly 04 and the first slider 02.

That is, the second plug assembly 04 can achieve limiting and abutment with the first slider 02 through the first groove 41. For example, as shown in FIG. 8, the second end 22 of the first slider 02 can enter the first groove 41 to limit the second plug assembly 04, so as to prevent the second plug assembly 04 from extending out of the second insertion hole 12. In an application scenario, the fourth plug assembly 010 is a European cone plug assembly. Such design can improve the anti-ejection effect on a European cone socket assembly and the corresponding user experience.

In other examples, a structure similar to the first groove may alternatively be used on other socket assemblies to further improve the anti-ejection effect.

Additionally and/or alternatively, as shown in FIGS. 2, 4 to 8, and 12, the support member 01 is further provided with a third insertion hole 13 (including 13a, 13b, and 13c), the conversion socket further includes a second slider 08 and a third plug assembly 09 (e.g., a third plug assembly 09 may at least include one or more pins or one or more prongs), the second slider 08 is connected to the support member 01 in a sliding manner along a third direction z, and the third direction z is perpendicular to the first direction x and the second direction y; the third plug assembly 09 is arranged on the support member 01, and at least a portion of the third plug assembly 09 can extend and retract along the second direction y in the third insertion hole 13, so as to abut against or separate from the second slider 08; the first slider 02 is provided with a first clamping portion 23 (e.g., a first clamping structure of the first slider 02 or a first clamp of the first sider 02 as shown in at least FIGS. 5 and 6), the second slider 08 includes a second clamping portion 83 (e.g., a second clamping structure of the second slider 08 or a second clamp of the second slider 08 as shown in at least FIGS. 5 and 7), and the first clamping portion 23 and the second clamping portion 83 are clamped or separated along the first direction x or the third direction z.

It should be noted that the second slider 08 is connected to the support member 01 in the sliding manner along the third direction z, and the support member 01 limits the second slider 08, such that the second slider 08 can only slide left and right along the third direction z; the first slider 02 and the second slider 08 limit each other through the first clamping portion 23 and the second clamping portion 83.

As shown in FIGS. 4, 5, and 8, the first slider 02, the second slider 08, the first plug assembly 03, the second plug assembly 04, and the third plug assembly 09 can be limited. Specifically, at least a portion of the first plug assembly 03, when extending out of the first insertion hole 11, abuts against the first end 21 and pushes the first slider 02 to move along the first direction x, such that the second end 22 of the first slider 02 abuts against the second plug assembly 04 to limit the second plug assembly 04 (as shown in the above example); (as shown in at least FIG. 5) as the first slider 02 moves along the first direction x, the first clamping portion 23 pushes the second clamping portion 83 to move along the third direction z until the second clamping portion 83 is fully clamped and limited with the first clamping portion 23, such that the second slider 08 can be located at a second preset position, and one side of the second slider 08 covers at least a portion of the third insertion hole 13, to prevent the third plug assembly 09 from extending out of the third insertion hole 13 and limit the third plug assembly 09.

As shown in FIG. 5 and FIG. 12, if at least a portion of the third plug assembly 09 extends out of the third insertion hole 13 along the second direction y, the third plug assembly 09 abuts against the second slider 08 and pushes the second slider 08 to move along the third direction z, such that the second clamping portion 83 pushes the first clamping portion 23 to move along the first direction x until the first clamping portion 23 is fully clamped and limited with the second clamping portion 83, the first slider 02 is located at a third preset position, the first end 21 of the first slider 02 covers at least a portion of the first insertion hole 11, and the second end 22 of the first slider 02 covers at least a portion of the second insertion hole 12, to prevent the first plug assembly 03 from extending out of the first insertion hole 11 and the second plug assembly 04 from extending out of the second insertion hole 12.

In the above example, when the first clamping portion 23 is fully clamped with the second clamping portion 83, the first slider 02 stops sliding along the first direction x, and the second slider 08 stops sliding along the second direction y; a plug portion of the first plug assembly 03 abuts against the first end 21 of the first slider 02, to further fix the positions of the first slider 02 and the second slider 08, thereby further improving the anti-ejection effect on the second plug assembly 04 and the third plug assembly 09; similarly, when the user needs to use the second plug assembly 04, the first slider 02 and the second slider 08 have a similar linkage effect as described above, to achieve the anti-ejection effect on the first plug assembly 03 and the third plug assembly 09.

With the rapid development of economy, global travel is becoming increasingly common. In different countries or regions, due to different socket specifications, users usually carry multi-country conversion sockets for plugs of their electrical or electronic products. Common conversion sockets currently in the market are mostly heavy and inconvenient to carry. Further, because a plurality of plug assemblies that can be used for different socket specifications are provided inside a conversion socket, when one of the plug assemblies is pulled out of the conversion socket for use, the other plug assemblies are easily interfered or stuck together. As a result, two or more plug assemblies extend out of the conversion socket at the same time, which not only affects normal use, but also may incur safety hazards such as an electric shock to a user, spark breakdown occurring in the socket, or a fire caused by socket overheating.

In this example, the first slider 02 is arranged on the support member 01, the first slider 02 slides along the first direction x, and the support member 01 limits the first slider 02, such that the first slider 02 can only slide left and right along the first direction x. When the first plug assembly 03 extends out of the first insertion hole 11, the first slider 02 can cover at least a portion of the second insertion hole 12, which can reduce the risk that the second plug assembly 04 is interfered or carried out of the second insertion hole 12. Similarly, when the second plug assembly 04 extends out of the second insertion hole 12, the first slider 02 can cover at least a portion of the first insertion hole 11, to reduce the risk that the first plug assembly 03 is interfered or carried out of the first insertion hole 11. Further, the second slider 08 and the first slider 02 are clamped or separated through the first clamping portion 23 and the second clamping portion 83, and the second slider 08 can abut against or separate from the third plug assembly 09, such that the first plug assembly 03, the second plug assembly 04, and the third plug assembly 09 limit each other, thereby further reducing the risk of simultaneous ejection of a plurality of plug assemblies in the conversion socket. Further, this example has a simple structure, can prevent interference between the plug assemblies without adding other limit mechanisms, and can reduce the overall size of the conversion socket and improve product portability. Further, this example has a simple structure, and facilitates multiplexing or further extension of functional modules of other specifications in the conversion socket. Therefore, this example can better reduce the risk of simultaneous ejection of the plug assemblies in the conversion socket, improve the use convenience and safety of the conversion socket, reduce product size to improve portability, reduce safety hazards, and improve product reliability and user experience.

In addition, this cross sliding structure has high strength, slides smoothly, and improves the user experience. Moreover, the structure is simple, the parts occupy a small space, other limit mechanisms are not needed, space occupation of the product can be reduced, and the portability can be improved.

In other examples, more plug assemblies or other functional modules can be further added by using the above principle. Such design is simple in structure, facilitates production, and can reduce costs and improve the compactness of the internal structure of the product, thereby reducing product size and improving product portability.

Additionally and/or alternatively, the support member 01 is provided with a limit assembly, and the limit assembly is used for limiting the movement of the first slider 02 along the first direction x.

The limit assembly of the support member 01 can improve the stability of the first slider 02 when moving along the first direction x, thereby improving product reliability.

Additionally and/or alternatively, the limit assembly may be a limit protrusion to limit the first slider 02 only along the first direction x, which facilitates assembly.

In other examples, the limit assembly may be a slide rail, and a sliding block is correspondingly provided on the first slider to limit the movement of the first slider along the first direction, so as to further improve the stability of the first slider during sliding.

Additionally and/or alternatively, the conversion socket further includes an upper shell 05 and a lower shell 06, the upper shell 05 is formed with a first through hole 51 (including 51a, 51b, and 51c) and a second through hole 52, the first through hole 51 is in communication with the first insertion hole 11. The second through hole 52 is in communication with the second insertion hole 12; the lower shell 06 and the upper shell 05 form an accommodating chamber; the support member 01, the first slider 02, the first plug assembly 03, and the second plug assembly 04 are arranged in the accommodating chamber.

In an application scenario, the upper shell 05 and the lower shell 06 form an accommodating chamber, and the plug portion of the first plug assembly 03 can extend out of the first insertion hole 11 along the second direction y, and then extend out of the first through hole 51 for standby; the plug portion of the second plug assembly 04 can extend out of the second insertion hole 12 along the second direction y, and then extend out of the second through hole 52 for standby. When the first plug assembly 03 extends out of the first through hole 51, the plug portion of the first plug assembly 03 pushes the first end 21 of the first slider 02 away from the first insertion hole 11 to move along the first direction x, such that the second end 22 of the first slider 02 covers at least a portion of the second insertion hole 12, to prevent the second plug assembly 04 from extending out of the second insertion hole 12; when the second plug assembly 04 extends out of the second through hole 52, the plug portion of the second plug assembly 04 pushes the second end 22 of the first slider 02 away from the second insertion hole 12 to move along the first direction x, such that the first end 21 of the first slider 02 covers at least a portion of the first insertion hole 11, to prevent the first plug assembly 03 from extending out of the first insertion hole 11, thereby improving use safety.

The above settings have the beneficial effect that the design of the upper shell 05 and the lower shell 06 can improve the aesthetics and use safety of the conversion socket and improve the anti-interference performance and reliability of the product.

Additionally and/or alternatively, the conversion socket further includes three operation members 07 (e.g., an operation device or a controller as shown in FIG. 9), which are connected to the first plug assembly 03, the second plug assembly 04, and the third plug assembly 09, to control the extension and retraction of the first plug assembly 03 in the first insertion hole 11, the extension and retraction of the second plug assembly 04 in the second insertion hole 12, and the extension and retraction of the third plug assembly 09 in the third insertion hole 13, respectively.

In an application scenario, the user can control the first plug assembly 03 to extend out of the first insertion hole 11 through the operation member 07 connected to the first plug assembly 03. After the first plug assembly 03 is used, the user can control the first plug assembly 03 to retract into the first insertion hole 11 through the operation member 07, namely, to reset. In an application scenario, in an early stage of the resetting process of the first plug assembly 03, at least a partial structure of the first plug assembly 03 always abuts against the first end 21 of the first slider 02. In a later stage of the resetting process, the structure of the first plug assembly 03 that abuts against the first slider 02 completely falls into the first insertion hole 11. In this case, the first plug assembly 03 may not affect the first slider 02, and the first slider 02 can be arranged to bounce back to its original position to cover at least a portion of the first insertion hole 11, or the first slider 02 can be arranged to remain in its current position, which is not limited.

Similarly, in an application scenario, the user can control the second plug assembly 04 to extend out of the second insertion hole 12 through the operation member 07 connected to the second plug assembly 04 or the third plug assembly 09. For example, after the second plug assembly 04 is used, this operation member 07 can control the structure of the second plug assembly 04 that abuts against the first slider 02, to completely fall into the second insertion hole 12, namely, to reset. The operation on the third plug assembly 09 is similar and will not be repeated here.

The above settings have the beneficial effect that the operation member 07 can facilitate user operation and control the extension and retraction of the first plug assembly 03, the second plug assembly 04, or the third plug assembly 09, which can improve user experience.

Additionally and/or alternatively, a limit column 15 extends from the side of the support member 01 away from the first slider 02 along the second direction y, the operation member 07 is provided with a limit hole 71, and the limit column 15 is at least partially arranged in the limit hole 71.

In an application scenario, as shown in FIG. 10, the support member 01 is provided with two limit columns 15, corresponding to the two operation members 07 respectively. The limit column 15 is at least partially arranged in the limit hole 71, and the operation member 07 can move along the extension direction of the limit column 15. The limit column 15 can support and limit the movement of the operation member 07, such that the operation member 07 can move only along the second direction, the directional accuracy and stability of movement of the operation member 07 can be improved, the first socket assembly or the second socket assembly can extend and retract more accurately along the second direction y in the first insertion hole 11 or the second insertion hole 12, the directional accuracy and stability of movement of the first socket assembly or the second socket assembly can be improved, and the user experience can be further improved.

In other examples, the support member may include only one limit column, the limit column is at least partially arranged in two limit holes of two operation members, and the two operation members can move along the extension direction of the limit column, namely, along the second direction.

Additionally and/or alternatively, as shown in FIG. 10, the cross-sectional size of the end of the limit column 15 near the first slider 02 is less than that of the other end, to form a sliding groove 151 at one end of the limit column 15; the operation member 07 includes a fixed portion 72, an operation portion 73, and an elastic member 74; the fixed portion 72 is connected to the first plug assembly 03 or the second plug assembly 04 in a sliding manner along a direction perpendicular to the second direction y; the operation portion 73 is arranged on the fixed portion 72; one end of the elastic member 74 is connected to the fixed portion 72, the other end of the elastic member 74 is connected to the first plug assembly 03 or the second plug assembly 04, and the elastic member 74 extends along the sliding direction of the fixed portion 72, where the depth direction of the sliding groove 151 is the same as the sliding direction of the fixed portion 72.

In an application scenario, the limit hole 71 of the operation member 07 is arranged on the fixed portion 72. When the user desires to use the first plug assembly 03 or the second plug assembly 04, the user controls the operation member 07 to move close to the first slider 02 along the second direction y. When the operation member 07 moves through the limit hole 71 to the sliding groove 151 of the limit column 15, because the cross-sectional size of the end of the limit column 15 near the first slider 02 is less than that of the other end and the depth direction of the sliding groove 151 is the same as the sliding direction, under the action of the elastic member 74, the fixed portion 72 slides relative to the first plug assembly 03 or the second plug assembly 04 along the direction perpendicular to the second direction y, and is eventually clamped onto the sliding groove, such that the operation member 07 is clamped onto the sliding groove 151 of the limit column 15. In this case, the sliding groove 151 can provide support for the operation member 07 and the first plug assembly 03 or the second plug assembly 04 connected to the operation member 07 in the sliding manner, thereby fixing the position of the first plug assembly 03 or the second plug assembly 04 for user's normal use.

Further, after the user uses the first plug assembly 03 or the second plug assembly 04, the operation member 07 can be pressed along the extension direction of the elastic member 74 to compress the elastic member 74, such that the fixed portion 72 slides close to the first plug assembly 03 or the second plug assembly 04 along the extension direction of the elastic member 74 to reset the limit hole 71, the operation member 07 may not be supported by the sliding groove 151 of the limit column 15, and the operation member 07 can drive, through the limit hole 71 and along the limit column 15, the first plug assembly 03 or the second plug assembly 04 to move along the second direction y away from the first insertion hole 11 or the second insertion hole 12, to complete the resetting and storage of the first plug assembly 03 or the second plug assembly 04.

The above settings have the beneficial effects that the fixed portion 72 is connected to the first plug assembly 03 or the second plug assembly 04 in the sliding manner along the direction perpendicular to the second direction y, and the depth direction of the sliding groove 151 is the same as the sliding direction, such that the fixed portion 72, when moving to the sliding groove 151 of the limit column 15, is clamped onto the sliding groove 151 under the action of the elastic member 74, and then the sliding groove 151 provides support force for the operation member 07 and the first plug assembly 03 or the second plug assembly 04 connected to the operation member 07 in the sliding manner, thereby fixing the position of the first plug assembly 03 or the second plug assembly 04; the fixed portion 72 can improve the control effect of the operation member 07 on the first plug assembly 03 or the second plug assembly 04; the operation portion 73 facilitates user's operation on the operation member 07 to improve user experience; the elastic member 74 can provide driving force for the sliding of the fixed portion 72, thereby improving use convenience and then user experience.

Additionally and/or alternatively, the first plug assembly 03 or the second plug assembly 04 is provided with a third through hole, the third through hole overlaps at least partially with the limit hole 71 of the operation member 07 in the second direction y, and the limit column 15 is at least partially arranged in this overlap area; the limit hole 71 of the operation member 07 is arranged at one end of the fixed portion 72, the first plug assembly 03 or the second plug assembly 04 is further provided with a clamping groove along the sliding direction of the fixed portion 72, the fixed portion 72 is at least partially slid in the clamping groove to achieve sliding connection, the operation portion 73 and the fixed portion 72 of the operation member 07 are arranged along the sliding direction of the fixed portion 72, and the elastic member 74 extends along the sliding direction of the fixed portion 72. Therefore, based on the above structure, the operation member 07 drives the first plug assembly 03 or the second plug assembly 04 to move in the second direction y and be fixed at a first preset position, such that the user uses the first plug assembly 03 or the second plug assembly 04 normally.

It should be noted that the first preset position refers to a position of the operation member 07 when fixed on the sliding groove of the limit column 15. In this case, the first plug assembly 03 or the second plug assembly 04 extends out of the corresponding first insertion hole 11 or second insertion hole 12 for user's normal use. The first preset position can be adjusted as needed by adjusting the position of the sliding groove.

Additionally and/or alternatively, the elastic member 74 may be a spring or another elastic mechanism, which is not limited.

Additionally and/or alternatively, the conversion socket includes an upper shell 05 and a lower shell 06, as well as the aforementioned operation member 07, where the upper shell 05 is formed with a first through hole 51 and a second through hole 52, the first through hole 51 is in communication with the first insertion hole 11, and the second through hole 52 is in communication with the second insertion hole 12; the lower shell 06 and the upper shell 05 form an accommodating chamber. The first through hole 51 and the second through hole 52 are arranged on a top wall of the upper shell 05, a side wall of the upper shell 05 extends towards one side near the accommodating chamber to form a second groove, the lower shell 06 and the upper shell 05 are arranged along the second direction y, and the lower shell 06 is connected to one end of the upper shell 05 to form the accommodating chamber. The one end of the upper shell 05 refers to the end of the side wall of the upper shell 05 away from the top wall of the upper shell 05. The support member 01, the first slider 02, the first plug assembly 03, and the second plug assembly 04 are arranged in the second groove, two sliding grooves 53 are formed on the side wall of the upper shell 05, the sliding grooves 53 extend along the second direction y, and the sliding grooves 53 correspond to the operation member 07 and extend along a movement trajectory of the operation member 07. The operation member 07 is at least partially arranged in the sliding groove 53. The portion, connected to the first plug assembly 03 or the second plug assembly 04, of the fixed portion 72 of the operation member 07 is located in the accommodating chamber, and the operation portion 73 of the operation member 07 is located outside the accommodating chamber, which facilitate user's operation. The design of the upper shell 05 and the lower shell 06 can improve the aesthetics and use safety of the conversion socket.

Additionally and/or alternatively, the depth direction of the sliding groove, the sliding direction of the fixed portion 72, and the extension direction of the elastic member 74 are arranged parallel to the arrangement direction of the operation portion 73 and the fixed portion 72 of the operation member 07, which facilitates user's operation on the operation member 07. In other examples, the depth direction of the sliding groove, the sliding direction of the fixed portion 72, and the extension direction of the elastic member 74 can be adjusted as needed, which is not limited.

In other examples, the second groove may alternatively be formed by the extension of the side wall of the lower shell towards the upper shell, and then the sliding groove is arranged on the side wall of the lower shell, without specific limitation.

Additionally and/or alternatively, as shown in FIG. 8, the end surface of the first end 21 of the first slider 02 is provided with a first inclined surface, and the angle between the first inclined surface and the side of the first end 21 of the first slider 02 away from the support member 01 is an acute angle; the end surface of the second end 22 of the first slider 02 is provided with a second inclined surface, and the angle between the second inclined surface and the side of the second end 22 of the first slider 02 away from the support member 01 is an acute angle.

It should be noted that, as shown in FIG. 8, the first inclined surface enables the formation of pushing force for the first slider 02 along the first direction x when the first plug assembly 03 moves along the second direction y and abuts against the first end 21 of the first slider 02. The second inclined surface has the similar effect, which will not be repeated here. At least a portion of the first plug assembly 03 is arranged near the first end 21 of the first slider 02, and the first end 21 of the first slider 02 can cover at least a portion of the first insertion hole 11. Because the end surface of the first end 21 of the first slider 02 is provided with the first inclined surface, and the angle between the first inclined surface and the side of the first end 21 of the first slider 02 away from the support member 01 is an acute angle, when the first plug assembly 03 extends out of the first insertion hole 11, the first end 21 of the first slider 02 can be pushed away, such that the first slider 02 moves close to the second plug assembly 04 along the first direction x. At least a portion of the second plug assembly 04 is arranged near the second end 22 of the first slider 02, and the second end 22 of the first slider 02 can cover at least a portion of the second insertion hole 12. Because the end surface of the second end 22 of the first slider 02 is provided with the second inclined surface, and the angle between the second inclined surface and the side of the second end 22 of the first slider 02 away from the support member 01 is an acute angle, when the second plug assembly 04 extends out of the second insertion hole 12, the second end 22 of the first slider 02 can be pushed away from the second insertion hole 12, and the first slider 02 moves away from the second insertion hole 12 along the second direction y.

Only the first inclined surface and the second inclined surface are arranged at two ends of the first slider 02, which not only facilitates the linkage between the first plug assembly 03 or the second plug assembly 04 and the first slider 02, but also does not require additional components. Such a structure is simple, can further reduce product size, improve the compactness of layout of various components in the accommodating chamber, and thus improve product portability.

In other examples, other mechanisms can be arranged at the two ends of the first slider to achieve the above effect, without limitation.

Additionally and/or alternatively, the first plug assembly 03 is provided with a third inclined surface on one side near the first end 21 of the first slider 02, and the third inclined surface is arranged parallel to the first inclined surface; the second plug assembly 04 is provided with a fourth inclined surface on one side near the second end 22 of the first slider 02, and the fourth inclined surface is arranged parallel to the second inclined surface.

When the first plug assembly 03 extends out of the first insertion hole 11, because the first plug assembly 03 is provided with the third inclined surface on one side near the first end 21 of the first slider 02, and the third inclined surface is arranged parallel to the first inclined surface, the smoothness of pushing the first plug assembly 03 away from the first end 21 of the first slider 02 can be further improved, such that the first slider 02 moves away from the first insertion hole 11 along the second direction y. This setting can improve the smoothness of user operation, achieve the anti-ejection effect of the first slider 02 on the second plug assembly 04 more smoothly, and improve use safety of the product. Similarly, when the second plug assembly 04 extends out of the second insertion hole 12, because the second plug assembly 04 is provided with the fourth inclined surface on one side near the second end 22 of the first slider 02, and the fourth inclined surface is arranged parallel to the second inclined surface, the smoothness of pushing the second plug assembly 04 away from the second end 22 of the first slider 02 can be further improved, such that the first slider 02 moves away from the second insertion hole 12 along the second direction y. This setting can improve the smoothness of user operation, achieve the anti-ejection effect of the first slider 02 on the first plug assembly 03 more smoothly, and improve use safety of the product.

By forming the third inclined surface on the first plug assembly 03 and the fourth inclined surface on the second plug assembly 04, the smoothness of linkage between the first plug assembly 03 or the second plug assembly 04 and the first slider 02 can be further improved. Such a structure is simple, and can improve the smoothness of user operation, reduce the quantity and size of product parts, prevent erroneous ejection of plug assemblies in the conversion socket more smoothly, and improve the use safety of the product.

Additionally and/or alternatively, as shown in FIG. 8, the second plug assembly 04 is provided with a first groove 41 on one side near the first slider 02, and a fourth inclined surface is formed on an inner wall of the first groove 41.

As shown in FIG. 8, the fourth inclined surface corresponds to the second inclined surface of the second end 22. When the first plug assembly 03 extends out of the first insertion hole 11, the first slider 02 is pushed to move towards the second insertion hole 12 along the first direction x, the second end 22 of the first slider 02 covers at least a portion of the second insertion hole 12 and is inserted into the first groove 41, and the second inclined surface of the second end 22 of the first slider 02 abuts against the fourth inclined surface formed on the inner wall of the first groove 41, which can further improve the anti-ejection effect on the second plug assembly 04.

In other examples, the fourth inclined surface and the second inclined surface may not be parallel, but slide relative to each other.

In an application scenario, the fourth plug assembly 010 is a European cone plug assembly. Such design can improve the anti-ejection effect and corresponding user experience of a European cone socket assembly.

In other examples, corresponding inclined surfaces can be further formed on other socket assemblies by using the first groove structure, to further improve the anti-ejection effect.

Additionally and/or alternatively, as shown in FIG. 5 to FIG. 7, the first clamping portion 23 includes a first clamping groove 231, a second clamping groove 232 and a third clamping groove 233, where the first clamping groove 231 is arranged in the middle of the side of the first slider 02 near the second slider 08, and the second clamping groove 232 and the third clamping groove 233 are arranged on two sides, opposite along the third direction z, of a bottom wall of the first clamping groove 231; the first clamping groove 231 penetrates through the first slider 02 along the third direction z; the second clamping portion 83 includes a fourth clamping groove 831, a fifth clamping groove 832 and a sixth clamping groove 833, where the fourth clamping groove 831 is arranged in the middle of the side of the second slider 08 near the first slider 02, and the fifth clamping groove 832 and the sixth clamping groove 833 are arranged on two sides, opposite along the first direction x, of a bottom wall of the fourth clamping groove 831; the fourth clamping groove 831 penetrates through the second slider 08 along the first direction x; where an inner wall of the first clamping groove 231 is spaced apart or clamped with an inner wall of the fifth clamping groove 832 and/or an inner wall of the sixth clamping groove 833 along the first direction x; where an inner wall of the fourth clamping groove 831 is spaced apart or clamped with an inner wall of the second clamping groove 232 and/or an inner wall of the third clamping groove 233 along the third direction z.

It should be noted that the second clamping portion 83 can slide on the bottom wall of the first clamping groove 231, and the first clamping portion 23 can slide on the bottom wall of the fourth clamping groove 831. The first clamping groove 231 is fitted with the fifth clamping groove 832 and the sixth clamping groove 833, and the fourth clamping groove 831 is fitted with the second clamping groove 232 and the third clamping groove 233.

The above settings have the beneficial effects that the first clamping groove 231 penetrates through the first slider 02 along the third direction z, and the inner wall of the first clamping groove 231 is spaced apart or clamped with the inner wall of the fifth clamping groove 832 and/or the inner wall of the sixth clamping groove 833 along the first direction x, such that the second clamping portion 83 can slide along the third direction z on the bottom wall of the first clamping groove 231; the bottom wall of the first clamping groove 231 is provided with the second clamping groove 232 and the third clamping groove 233 along the third direction z, which can limit the movement of the second clamping portion 83 in the third direction z, thereby limiting the movement of the second slider 08 in the third direction z; further, the fourth clamping groove 831 penetrates through the second slider 08 along the first direction x, and the inner wall of the fourth clamping groove 831 is spaced apart or clamped with the inner wall of the second clamping groove 232 and/or the inner wall of the third clamping groove 233 along the third direction z, such that the first clamping groove 23 can slide along the first direction x on the bottom wall of the fourth clamping groove 831; the bottom wall of the fourth clamping groove 831 is further provided with the fifth clamping groove 832 and the sixth clamping groove 833 along the first direction x, which can limit the movement of the first clamping groove 23 in the first direction x, thereby limiting the movement of the first slider 02 in the first direction x; further, the first clamping portion 23 can limit the second slider 08, and the second clamping portion 83 can limit the first slider 02, such that the complete clamping of the two clamping portions can achieve relative sliding and limiting, occupy less space, obtain a simple structure, achieve a higher-strength anti-ejection effect of the first slider 02 or the second slider 08 on the plurality of plug assemblies, and improve product portability and user experience.

Additionally and/or alternatively, two opposite inner walls of the first clamping groove 231 along the first direction x are arranged in a V-shaped structure, and the inner walls of the fifth clamping groove 832 and the sixth clamping groove 833 are each arranged in a V-shaped structure that matches the inner walls of the first clamping groove 231; two opposite inner walls of the fourth clamping groove 831 along the third direction z are arranged in a V-shaped structure, and the inner walls of the second clamping groove 232 and the third clamping groove 233 are each arranged in a V-shaped structure that matches the inner walls of the fourth clamping groove 831.

Additionally and/or alternatively, two opposite inner walls of the first clamping groove 231 along the first direction x are arranged in a V-shaped structure, for example, the V-shaped structure may be formed by two inclined surfaces, and the inner walls of the fifth clamping groove 832 and the sixth clamping groove 833 match the inner walls of the V-shaped structure of the first clamping groove 231; two opposite inner walls of the fourth clamping groove 831 along the third direction z are arranged in a V-shaped structure, for example, the V-shaped structure may be formed by two inclined surfaces, and the inner walls of the second clamping groove 232 and the third clamping groove 233 match the inner walls of the V-shaped structure of the fourth clamping groove 831.

The above settings are simple in structure. The V-shaped structure facilitates the conversion of pushing force for the first slider 02 along the first direction x into pushing force for the second slider 08 along the third direction z, or the V-shaped structure facilitates the conversion of pushing force for the second slider 08 along the third direction z into pushing force for the first slider 02 along the first direction x, and achieves good sliding and clamping limit effects.

In other examples, the direction and distance of relative sliding of the first slider and the second slider can be adjusted by adjusting the shape of the first clamping portion and the shape of the second clamping portion, thereby being able to adapt to product requirements of different specifications. For example, the clamping portions may be in other shapes without limitation.

Additionally and/or alternatively, as shown in FIG. 6 and FIG. 7, the V-shaped structure of the first clamping groove 231 protrudes into the first clamping groove 231; the V-shaped structure of the fourth clamping groove 831 protrudes into the fourth clamping groove 831.

The first clamping groove 231 is fitted with the fifth clamping groove 832 and the sixth clamping groove 833, and the fourth clamping groove 831 is fitted with the second clamping groove 232 and the third clamping groove 233.

Alternatively, in other examples, the V-shaped structure of the first clamping groove 231 may be arranged to face away from the first clamping groove 231 and depress towards the first end 21 or the second end 22 of the first slider 02; the V-shaped structure of the fourth clamping groove 831 faces away from the fourth clamping groove 831 and depresses towards the third end 81 or the fourth end 82 of the second slider, without specific limitation.

Additionally and/or alternatively, when the conversion socket includes the upper shell 05, the lower shell 06, the second slider 08 and the third plug assembly 09, the operation member 07 connected to the third plug assembly 09, the limit column 15 on the support member 01, the sliding groove 53 on the side wall of the upper shell 05, and the third through hole can be correspondingly provided. The implementation is similar to the above relevant description of the first plug assembly 03 or the second plug assembly 04, and will not be repeated here.

Additionally and/or alternatively, the support member 01 is further provided with a fourth insertion hole 14 (including 14a, 14b, and 14c), the second slider 08 is provided with a third end 81 and a fourth end 82, the third end 81 and the fourth end 82 are arranged along the third direction z, the conversion socket further includes a fourth plug assembly 010 (e.g., a fourth plug assembly 010 may at least include one or more pins or one or more prongs), the fourth plug assembly 010 is arranged on the support member 01, and at least a portion of the fourth plug assembly 010 can extend and retract along the second direction y in the fourth insertion hole 14, so as to abut against or separate from the fourth end 82; at least a portion of the third plug assembly 09 can extend and retract along the second direction y in the third insertion hole 13, so as to abut against or separate from the third end 81.

Specifically, as shown in FIG. 12, if at least a portion of the third plug assembly 09 extends out of the third insertion hole 13 along the second direction y, the third plug assembly 09 abuts against the third end 81 and pushes the second slider 08 to move along the third direction z, such that the fourth end 82 covers at least a portion of the fourth insertion hole 14 to prevent the fourth plug assembly 010 from extending out of the fourth insertion hole 14; if at least a portion of the fourth plug assembly 010 extends out of the fourth insertion hole 14, the fourth plug assembly 010 abuts against the fourth end 82 and pushes the second slider 08 to move along the third direction z, such that the third end 81 covers at least a portion of the third insertion hole 13 to prevent the third plug assembly 09 from extending out of the third insertion hole 13. Meanwhile, as shown in FIG. 5, the second slider 08 moves along the third direction z, such that the second clamping portion 83 pushes the first clamping portion 23 to move along the first direction x until the first clamping portion 23 is fully clamped with the second clamping portion 83, the first slider 02 is located at the third preset position, the first end 21 of the first slider 02 covers at least a portion of the first insertion hole 11, and the second end 22 covers at least a portion of the second insertion hole 12, to prevent the first plug assembly 03 from extending out of the first insertion hole 11 and the second plug assembly 04 from extending out of the second insertion hole 12.

In the above example, the first clamping portion 23 is fully clamped with the second clamping portion 83, such that the first slider 02 stops sliding along the first direction x, and the second slider 08 stops sliding along the second direction y; further, the plug portion of the first plug assembly 03 abuts against the first end 21 of the first slider 02, to further fix the positions of the first slider 02 and the second slider 08, thereby further improving the anti-ejection effect on the second plug assembly 04, the third plug assembly 09, and the fourth plug assembly 010; similarly, when the user needs to use the second plug assembly 04, the first slider 02 and the second slider 08 have a similar linkage effect as described above to achieve the anti-ejection effect on the first plug assembly 03, the third plug assembly 09, and the fourth plug assembly 010.

The above settings have the beneficial effects that the fourth plug assembly 010 can further increase the diversity of plug assemblies of the conversion socket and further improve the scenario applicability of the product; further, the linkage between the second slider 08 and the first slider 02 can reduce the risk of simultaneous ejection of plug assemblies in the conversion socket, and this cross sliding structure has high strength, slides smoothly, and improves user experience; such a structure is simple, does not need to add other limiting mechanisms, can reduce the risk of simultaneous ejection of plug assemblies when the conversion socket including four different plug assemblies is used, and can further reduce space occupation of the product and improve portability.

Additionally and/or alternatively, when the conversion socket includes the upper shell 05, the lower shell 06, the second slider 08, the third plug assembly 09 and the fourth plug assembly 010, the operation member 07 connected to the fourth plug assembly 010, the limit column 15 on the support member 01, the sliding groove 53 on the side wall of the upper shell 05, and the third through hole can be correspondingly provided. The implementation is similar to the above relevant description of the first plug assembly 03 or the second plug assembly 04, and will not be repeated here.

Additionally and/or alternatively, the end surface of the third end 81 of the second slider 08 is provided with a fifth inclined surface, and the angle between the fifth inclined surface and the side of the third end 81 of the second slider 08 away from the support member 01 is an acute angle; the end surface of the fourth end 82 of the second slider 08 is provided with a sixth inclined surface, and the angle between the sixth inclined surface and the side of the fourth end 82 of the second slider 08 away from the support member 01 is an acute angle.

It should be noted that, as shown in FIG. 12, the fifth inclined surface enables the formation of pushing force for the second slider 08 along the third direction z when the third plug assembly 09 moves along the second direction y and abuts against the third end 81 of the second slider 08. The sixth inclined surface has the similar effect, which will not be repeated here.

By forming the fifth inclined surface and the sixth inclined surface, the smoothness of linkage between the third plug assembly 09 or the fourth plug assembly 010 and the second slider 08 can be further improved. Such a structure is simple, and can improve the smoothness of user operation, reduce the quantity and size of product parts, prevent erroneous ejection of plug assemblies in the conversion socket more smoothly, and improve the use safety of the product.

Additionally and/or alternatively, in other examples, the third plug assembly is provided with a seventh inclined surface on one side near the third end of the second slider, and the seventh inclined surface is arranged parallel to the fifth inclined surface; the fourth plug assembly is provided with an eighth inclined surface on one side near the third end of the second slider, and the eighth inclined surface is arranged parallel to the sixth inclined surface.

Additionally and/or alternatively, the first plug assembly 03 is a British plug assembly, the second plug assembly 04 is a European plug assembly, the third plug assembly 09 is a Chinese plug assembly, and the fourth plug assembly 010 is an American plug assembly. Taking the British plug assembly as a reference position, as shown in FIG. 11, the British plug assembly and the European plug assembly are arranged along the first direction x; in the third direction z, the American plug assembly is at 90 degrees on the right of the British plug assembly, the left of the British plug assembly is perpendicular to a live wire pin direction of the Chinese plug assembly, and the European cone plug assembly is arranged at the top. Such arrangement can reduce the overall distance from a contour edge of a plug to an outer edge of the product while meeting a safety distance, and achieves a small-volume arrangement space. This setting can further improve the scenario applicability of the conversion socket, user experience, and portability of the product.

In other examples, the design principle of cross clamping of the first slider and the second slider can be used to further add more plug assemblies or other functional modules, so as to further enrich the applicable scenarios of the conversion socket. Such design is simple in structure, facilitates production, and can reduce costs and improve the compactness of the internal structure of the product, thereby reducing product size and improving product portability.

Additionally and/or alternatively, the British plug assembly further includes a British plug fuse 011 to meet normal usage requirements.

Additionally and/or alternatively, the conversion socket further includes a conductive copper sheet to further reduce assembly difficulty and increase energy efficiency.

Additionally and/or alternatively, the conversion socket further includes a printed circuit board (PCB) assembly 012, and the PCB assembly 012 can connect a plurality of electronic elements together to form a complete circuit. Compared to conventional point-to-point connections, circuit elements are arranged on one plane of the PCB assembly 012, such that the electronic product is more compact and lightweight, and the performance and portability of the product can be improved; further, the PCB assembly 012 is relatively simple in production and assembly and can be produced in large scale, which can reduce the manufacturing and maintenance costs of the product.

Additionally and/or alternatively, the conversion socket further includes an alternating current (AC) output module 013, and the AC output module 013 outputs alternating current, such that the conversion socket is more suitable for daily electricity use, and the scenario applicability of the product can be improved. Further, the AC output module 013 in this example includes output insertion holes, which can adapt to functional modules of various specifications and further improve the scenario applicability of the product.

In other examples, the conversion socket further includes a direct current (DC) output module, and the DC output module can be separately inserted into the output insertion hole of the AC output module, which can further improve the scenario applicability of the product. The separate design can further improve the portability and user experience of the product. The DC output module outputs direct current.

In other examples, similar improvements can be made to the conversion socket, and will not be repeated here.

Different from the prior art, in the present application, the first slider is arranged on the support member, the first slider slides along the first direction, and the support member limits the first slider, such that the first slider can only slide left and right along the first direction; when the first plug assembly extends out of the first insertion hole, the first slider can cover at least a portion of the second insertion hole, which can reduce the risk that the second plug assembly is interfered or carried out of the second insertion hole; similarly, when the second plug assembly extends out of the second insertion hole, the first slider can cover at least a portion of the first insertion hole, to reduce the risk that the first plug assembly is interfered or carried out of the first insertion hole; further, the second slider and the first slider are clamped or separated through the first clamping portion and the second clamping portion, and the second slider can abut against or separate from the third plug assembly, such that the first plug assembly, the second plug assembly, and the third plug assembly limit each other, thereby further reducing the risk of simultaneous ejection of the plurality of plug assemblies in the conversion socket; further, the present application has a simple structure, can prevent interference between the plug assemblies without adding other limit mechanisms, and can reduce the overall size of the conversion socket and improve product portability; further, the present application has a simple structure, and facilitates multiplexing or further extension of functional modules of other specifications in the conversion socket. Therefore, the present application can better reduce the risk of simultaneous ejection of the plug assemblies in the conversion socket, improve the use convenience and safety of the conversion socket, reduce product size to improve portability, reduce safety hazards, and improve product reliability and user experience.

Described above are examples of the present application, and the scope of the present application is not limited thereto. Any equivalent structure or equivalent process transformation made using the description and accompanying drawings of the present application, directly or indirectly applied in other related fields, is also included in the scope of protection of the present application.

What is claimed is:

1. A conversion socket, comprising:
a support layer comprising a first insertion hole, a second insertion hole, and a third insertion hole;
a first slider connected to the support layer in a sliding manner along a first direction, wherein the first slider comprises a first end and a second end, and the first end and the second end are arranged along the first direction;
a first plug assembly arranged on the support layer, wherein at least a portion of the first plug assembly extends or retracts along a second direction in the first insertion hole, to abut against or separate from the first end of the first slider;
a second plug assembly arranged on the support layer, wherein at least a portion of the second plug assembly extends or retracts along the second direction in the second insertion hole, to abut against or separate from the second end of the first slider, wherein the second direction is perpendicular to the first direction;
a second slider connected to the support layer in a sliding manner along a third direction, wherein the third direction is perpendicular to the first direction and the second direction; and
a third plug assembly arranged on the support layer, wherein at least a portion of the third plug assembly extends or retracts along the second direction in the third insertion hole, to abut against or separate from the second slider,
wherein the first slider comprises a first clamp, the second slider comprises a second clamp, and the first clamp and the second clamp are clamped or separated along the first direction or the third direction.

2. The conversion socket according to claim 1, wherein the first clamp comprises a first clamping groove, a second clamping groove and a third clamping groove, wherein the first clamping groove is arranged in a middle of a side of the first slider near the second slider, and the second clamping groove and the third clamping groove are arranged on two sides, opposite along the third direction, of a bottom wall of the first clamping groove, the first clamping groove penetrates through the first slider along the third direction,
wherein the second clamp comprises a fourth clamping groove, a fifth clamping groove and a sixth clamping groove, wherein the fourth clamping groove is arranged in a middle of a side of the second slider near the first slider, and the fifth clamping groove and the sixth clamping groove are arranged on two sides, opposite along the first direction, of a bottom wall of the fourth clamping groove, the fourth clamping groove penetrates through the second slider along the first direction,
wherein an inner wall of the first clamping groove is spaced apart or clamped with an inner wall of the fifth clamping groove and/or an inner wall of the sixth clamping groove along the first direction, and
wherein an inner wall of the fourth clamping groove is spaced apart or clamped with an inner wall of the second clamping groove and/or an inner wall of the third clamping groove along the third direction.

3. The conversion socket according to claim 2, wherein:
two opposite inner walls of the first clamping groove along the first direction are arranged in a V-shaped structure, and the inner wall of the fifth clamping groove and the inner wall of the sixth clamping groove are each arranged in a V-shaped structure that matches the two opposite inner walls of the first clamping groove, and
two opposite inner walls of the fourth clamping groove along the third direction are arranged in a V-shaped structure, and the inner wall of the second clamping groove and the inner wall of the third clamping groove are each arranged in a V-shaped structure that matches the two opposite inner walls of the fourth clamping groove.

4. The conversion socket according to claim 3, wherein the V-shaped structure of the first clamping groove protrudes into the first clamping groove, and
the V-shaped structure of the fourth clamping groove protrudes into the fourth clamping groove.

5. The conversion socket according to claim 1, wherein the support layer further comprises a fourth insertion hole, the second slider comprises a third end and a fourth end, the third end and the fourth end are arranged along the third direction, and the conversion socket further comprises:
a fourth plug assembly arranged on the support layer, wherein at least a portion of the fourth plug assembly extends or retracts along the second direction in the fourth insertion hole, to abut against or separate from the fourth end,
wherein at least a portion of the third plug assembly extends or retracts along the second direction in the third insertion hole, to abut against or separate from the third end.

6. The conversion socket according to claim 1, wherein the second plug assembly comprises a first groove on one side near the first slider, and the first slider is in clamping fit with the first groove to achieve the abutment between the second plug assembly and the first slider.

7. The conversion socket according to claim 6, wherein an end surface of the first end comprises a first inclined surface, and an angle between the first inclined surface and a side of the first end away from the support layer is an acute angle, and
an end surface of the second end comprises a second inclined surface, and an angle between the second inclined surface and a side of the second end away from the support layer is an acute angle.

8. The conversion socket according to claim 1, further comprising:
three controllers, which are connected to the first plug assembly, the second plug assembly, and the third plug assembly, to control the extension and retraction of the first plug assembly in the first insertion hole, the extension and retraction of the second plug assembly in the second insertion hole, and the extension and retraction of the third plug assembly in the third insertion hole, respectively.

9. The conversion socket according to claim 8, wherein a limit column extends from a side of the support layer away from the first slider along the second direction, at least one of the three controllers comprises a limit hole, and the limit column is at least partially arranged in the limit hole.

10. The conversion socket according to claim 1, further comprising:
an upper shell formed with a first through hole and a second through hole, wherein the first through hole is in communication with the first insertion hole, and the second through hole is in communication with the second insertion hole; and
a lower shell forming an accommodating chamber with the upper shell, wherein the support layer, the first slider, the first plug assembly, and the second plug assembly are arranged in the accommodating chamber.

11. A conversion socket, comprising:
a first slider configured to slide along a first direction, wherein the first slider comprises a first end and a second end, and the first end and the second end are arranged along the first direction;
a first plug assembly, wherein at least a portion of the first plug assembly is configured to extend or retract along a second direction in a first insertion hole, to abut against or separate from the first end of the first slider;
a second plug assembly, wherein at least a portion of the second plug assembly is configured to extend or retract along a second direction in a second insertion hole, to abut against or separate from the second end of the first slider, wherein the second direction is perpendicular to the first direction;
a second slider configured to slide along a third direction, wherein the third direction is perpendicular to the first direction and the second direction; and
a third plug assembly, wherein at least a portion of the third plug assembly is configured to extend or retract along the second direction in a third insertion hole, to abut against or separate from the second slider.

12. The conversion socket according to claim 11, further comprising a support layer, and wherein the first and second sliders are connected to the support layer, the first, second and third plug assemblies are arranged on the support layer, and the first, second, and third insertion holes are mounted through the support layer.

13. The conversion socket according to claim 12, wherein the second slider comprises a third end and a fourth end, the third end and the fourth end are arranged along the third direction, and the conversion socket further comprises:
a fourth plug assembly, wherein at least a portion of the fourth plug assembly is configured to extend or retract along the second direction in a fourth insertion hole, to abut against or separate from the fourth end, wherein the fourth plug assembly is arranged on the support layer and the fourth insertion hole is mounted through the support layer,
wherein at least a portion of the third plug assembly is configured to extend or retract along the second direction in the third insertion hole, to abut against or separate from the third end.

14. The conversion socket according to claim 12, further comprising:
an upper shell formed with a first through hole and a second through hole, wherein the first through hole is in communication with the first insertion hole, and the second through hole is in communication with the second insertion hole; and
a lower shell forming an accommodating chamber with the upper shell, wherein the support layer, the first slider, the first plug assembly, and the second plug assembly are arranged in the accommodating chamber.

15. The conversion socket according to claim 11, wherein the first slider comprises a first clamp, the second slider comprises a second clamp, and the first clamp and the second clamp are clamped or separated along the first direction or the third direction.

16. The conversion socket according to claim 15, wherein the first clamp comprises a first clamping groove, a second clamping groove and a third clamping groove, wherein the first clamping groove is arranged in a middle of a side of the first slider near the second slider, and the second clamping groove and the third clamping groove are arranged on two sides, opposite along the third direction, of a bottom wall of the first clamping groove, the first clamping groove penetrates through the first slider along the third direction, and
the second clamp comprises a fourth clamping groove, a fifth clamping groove and a sixth clamping groove, wherein the fourth clamping groove is arranged in a middle of a side of the second slider near the first slider, and the fifth clamping groove and the sixth clamping groove are arranged on two sides, opposite along the first direction, of a bottom wall of the fourth clamping groove, the fourth clamping groove penetrates through the second slider along the first direction,
wherein an inner wall of the first clamping groove is spaced apart or clamped with an inner wall of the fifth clamping groove and/or an inner wall of the sixth clamping groove along the first direction, and
wherein an inner wall of the fourth clamping groove is spaced apart or clamped with an inner wall of the second clamping groove and/or an inner wall of the third clamping groove along the third direction.

17. The conversion socket according to claim 16, wherein:
two opposite inner walls of the first clamping groove along the first direction are arranged in a V-shaped structure, and the inner wall of the fifth clamping groove and the inner wall of the sixth clamping groove are each arranged in a V-shaped structure that matches the two opposite inner walls of the first clamping groove, and
two opposite inner walls of the fourth clamping groove along the third direction are arranged in a V-shaped structure, and the inner wall of the second clamping groove and the inner wall of the third clamping groove are each arranged in a V-shaped structure that matches the two opposite inner walls of the fourth clamping groove.

18. The conversion socket according to claim 17, wherein the V-shaped structure of the first clamping groove protrudes into the first clamping groove, and
the V-shaped structure of the fourth clamping groove protrudes into the fourth clamping groove.

19. The conversion socket according to claim 11, further comprising:
three controllers, which are connected to the first plug assembly, the second plug assembly, and the third plug assembly, to control the extension and retraction of the first plug assembly in the first insertion hole, the extension and retraction of the second plug assembly in the second insertion hole, and the extension and retraction of the third plug assembly in the third insertion hole, respectively.

20. The conversion socket according to claim 19, wherein a limit column extends from a side of the support layer away from the first slider along the second direction, at least one of the three controllers comprises a limit hole, and the limit column is at least partially arranged in the limit hole.
